(19) United States
(12) Patent Application Publication
(10) Pub. No.: US 2010/0147188 A1
(43) Pub. Date: Jun. 17, 2010

(54) Graphite nanoplatelets and compositions

(76) Inventors: Marc Mamak, New City, NY (US); Urs Leo Stadler, Madison, NJ (US); Sungyeun Choi, Tarrytown, NY (US); Enzo Cordola, Mount Vernon, NY (US)

Correspondence Address: BASF Performance Products LLC;Patent Department, 540 White Plains Road, P.O. Box 2005, Tarrytown, NY, 10591, US

(21) Appl. No.: 12/380,365

(22) Filed: Feb. 26, 2009

Related U.S. Application Data
(60) Provisional application No. 61/067,478, filed on Feb. 28, 2008.

(51) Int. Cl. C09D 11/00; C01B 31/04; C09C 1/46

(52) U.S. Cl. 106/31.13; 423/448; 428/402; 106/472; 977/773

(57) ABSTRACT

Disclosed are graphite nanoplatelets produced by a process which comprises thermal plasma expansion of intercalated graphite to produce expanded graphite followed by exfoliation of the expanded graphite, where the exfoliation step is selected from ultrasonication, wet milling and controlled caviation and where greater than 95% of the graphite nanoplatelets have a thickness of from about 0.34 nm to about 50 nm and a length and width of from about 500 nm to about 50 microns. The intercalated graphite is intercalated for example with a mixture of sulfuric and nitric acids. The plasma reactor for example employs an RF induction plasma torch. All three exfoliation methods are performed in an organic solvent or water. The exfoliation steps may be performed with the aid of for example a nonionic surfactant. Also disclosed are plastic, ink, coating, lubricant or grease compositions comprising the graphite nanoplatelets.

This application claims benefit of U.S. provisional app. No. 61/067,478, filed Feb. 28, 2008, the contents of which are incorporated by reference.

The present invention is aimed at graphite nanoplatelets prepared by thermal plasma expansion of intercalated graphite followed by exfoliation of the expanded graphite by a variety of means. The present invention is also aimed at polymers, coatings, inks, lubricants and greases containing the graphite nanoplatelets.

### BACKGROUND

Polymer composites of nano-scaled graphite have a variety of desirable characteristics, for example unusual electronic properties and/or strength. Graphene sheets, one-atom thick two-dimensional layers of carbon, as well as carbon nanotubes have been studied and sought after for some time. Likewise, nano-scaled graphite, or graphite nanoplatelets have been studied as an alternative to graphene sheets or carbon nanotubes.

Useful are polymer composites of graphite nanoplatelets. Also useful are coatings and inks containing graphite nanoplatelets. Also useful are lubricants and greases containing graphite nanoplatelets.

The present invention provides graphite nanoplatelets prepared in a continuous and scalable method.

Stankovich, et al., in Nature, Vol. 442, July, 2006, pp. 282-286, teaches polystyrene-graphene composites. The graphene is prepared by treating graphite oxide with phenyl isocyanate. The isocyanate functionalized graphite oxide is exfoliated by ultrasonication in DMF. Polystyrene is added to the resulting dispersion in DMF. The dispersed material is reduced with dimethylhydrazine. Coagulation of the polymer composite is accomplished by adding the DMF solution to a large volume of methanol. The coagulated composite is isolated and crushed to a powder.

U.S. Patent Pub. No. 2007/0131915 discloses a method of making a dispersion of polymer coated reduced graphite oxide nanoplatelets. For instance, graphite oxide is immersed in water and treated with ultrasonication to exfoliate individual graphite oxide nanoplatelets into the water. The dispersion of graphite oxide nanoplatelets is then subjected to chemical reduction to remove at least some of the oxygen functionalities.

U.S. Pat. No. 6,872,330 is aimed at a process to produce nanomaterials. The nanomaterials are prepared by intercalating ions into layered compounds, exfoliating to create individual layers and then sonicating to produce nanotubes, nanosheets, etc. For instance, carbon nanomaterials are prepared by heating graphite in the presence of potassium to form a first stage intercalated graphite. Exfoliation in ethanol creates a dispersion of carbon sheets. Upon sonication carbon nanotubes are prepared. The graphite may be intercalated with alkali, alkali earth or lanthanide metals.

U.S. Patent Pub. No. 2007/0284557 is aimed at transparent and conductive films comprising at least one network of graphene flakes. Commercially available graphene flakes are dispersed in an appropriate solvent or in water with the aid of a surfactant. The dispersion is sonicated and then centrifuged to remove larger flakes. After filtering, a graphene film is recovered. The film may be pressed against a plastic substrate.

U.S. Pat. No. 7,071,258 is focused on a process for preparing graphene plate. The process comprises partially or fully carbonizing a precursor polymer or heat treating petroleum or coal tar pitch to produce a polymeric carbon comprising graphite crystallites containing sheets of graphite plane. The polymeric carbon is exfoliated and subjected to mechanical attrition. The exfoliation treatment comprises chemical treatment, intercalation, foaming, heating and/or cooling steps. For instance, the pyrolyzed polymer or pitch material is subjected to chemical treatment selected from oxidizing or intercalating solutions, for instance H₂SO₄, HNO₃, KMnO₄, FeCl₃, etc. The intercalated graphite is then expanded using foaming or blowing agents. Mechanical attrition comprises pulverization, grinding, milling, etc.

Manning, et al., in Carbon, 37 (1999), pp. 1159-1164 teaches the synthesis of exfoliated graphite. Fluorine intercalated graphite is subjected to atmospheric pressure 27.12 MHz inductively coupled argon plasma.

U.S. Patent Pub. Nos. 2006/0241237 and 2004/0127621 teach the expansion of intercalated graphite by microwaves or radiofrequency waves.

U.S. Pat. Nos. 5,776,372 and 6,024,900 teach carbon composites comprising an expanded graphite and a thermoplastic or thermosetting resin.

U.S. Pat. No. 6,395,199 is aimed at a process for providing increased electrical and/or thermal conductivity to a material by applying particles of expanded graphite to a substrate. The graphite particles may be incorporated into a substrate.

U.S. 2008/0149363 is aimed at compositions comprising a polyolefin polymer and an expanded graphite. Specifically disclosed are conductive formulations for cable components.

WO 2008/060703 teaches a process for the production of nanostructures.

U.S. 2004/0217332 discloses electrically conductive compositions composed of thermoplastic polymers and expanded graphite.

U.S. Patent Pub. No. 2007/0092432 is aimed at thermally exfoliated graphite oxide.

U.S. Pat. No. 6,287,694 is aimed at a method for preparing expanded graphite.

U.S. Pat. No. 4,895,713 discloses a method for intercalating graphite.

WO 2008/045778 is aimed at graphene rubber nanocomposites.

U.S. Pat. No. 5,330,680 teaches a method for preparing fine graphite particles.

U.S. 2008/242566 discloses the use of nanomaterials as a viscosity modifier and thermal conductivity improver for gear oil and other lubricating oil compositions.

U.S. Pat. No. 7,348,298 teaches fluid media such as oil or water containing carbon nanomaterials in order to enhance the thermal conductivity of the fluid.

The U.S. patents and patent publications listed herein are incorporated by reference.

There remains a need for a continuous, scalable method to produce graphite nanoplatelets.

### SUMMARY

Disclosed are graphite nanoplatelets produced by a process which comprises
thermal plasma expansion of intercalated graphite to produce expanded graphite followed by
exfoliation of the expanded graphite,

where the exfoliation step is selected from ultrasonication, wet milling and controlled caviation and

where greater than 95% of the graphite nanoplatelets have a thickness of from about 0.34 nm to about 50 nm and a length and width of from about 500 nm to about 50 microns.

Also disclosed are compositions comprising a plastic, ink, coating, lubricant or grease substrate, which substrates have incorporated therein graphite nanoplatelets,

where the graphite nanoplatelets are produced by a process which comprises

thermal plasma expansion of intercalated graphite to produce expanded graphite followed by

exfoliation of the expanded graphite,

where the exfoliation step is selected from ultrasonication, wet milling and controlled caviation and

where greater than 95% of the graphite nanoplatelets have a thickness of from about 0.34 nm to about 50 nm and a length and width of from about 500 nm to about 50 microns.

### DETAILED DISCLOSURE

Intercalated graphite is disclosed for example in U.S. Pat. No. 4,895,713, the contents of which are hereby incorporated by reference.

The intercalated graphite is also referred to as expandable graphite flakes or intumescent flake graphite. It is commercially available as GRAFGUARD from GrafTech International Ltd, Parma, Ohio. Expandable graphite is also available from Asbury Carbons, Asbury, N.J. Suitable grades are GRAFGUARD 220-80N, GRAFGUARD 160-50N, ASBURY 1721 and ASBURY 3538. These products are prepared by intercalating natural graphite with a mixture of sulfuric and nitric acids.

Graphite may also be intercalated with hydrogen peroxide.

Graphite oxide is also a suitable intercalated graphite, not yet commercially available. It is prepared by treating natural graphite with fuming H₂SO₄ plus HNO₃ plus a strong oxidant such as KClO₃ or KMnO₄ (Hummer method).

It is possible to also employ synthetic graphite in place of natural graphite.

Other forms of intercalated graphite may be employed, such as those disclosed in U.S. Pat. No. 6,872,330. Graphite may be intercalated with vaporizable species such as a halogen, an alkali metal or an organometallic reagent such as butyl lithium.

Plasma reactors are known and disclosed for instance in U.S. Pat. No. 5,200,595. The present invention employs an RF (radio frequency) induction plasma torch. Induction plasma torches are available for instance from Tekna Plasma Systems Inc., Sherbrooke, Quebec.

The present plasma reactor is equipped with an injection probe designed for powder injection. The powder feed rate is from about 0.4 to about 20 kg/hr. For instance, the powder feed rate is from about 5 to about 10 kg/hr. The powder feeder is for example a fluidized bed feeder or a vibratory, disc or suspension feeder.

Argon is employed as the sheath, carrier, dispersion and quench gases. A second gas may be added to each of these inputs, for example argon/hydrogen, argon/helium, argon/nitrogen, argon/oxygen or argon/air.

The residence time of the intercalated graphite powder is on the order of milliseconds, for instance from about 0.005 to about 0.5 seconds.

The torch power is from about 15 to about 80 kW. It is possible to achieve up to 200 kW or higher.

Thermal plasma torches other than RF may be employed, for example a DC arc plasma torch or a microwave discharge plasma.

The reactor pressure range is from about 200 torr to atmospheric pressure, or from about 400 to about 700 torr.

The temperature achieved with the plasma reactor is from about 5000K to about 10,000K or higher.

An advantage of the plasma expansion process is that it is a continuous, high throughput process. It is more efficient compared to an electric/gas furnace or microwave oven. The present plasma approach achieves a severe thermal shock. Thermal shock is defined as temperature difference achieved per unit time. RF plasma can achieve temperatures greater than 8000K. For example, if the intercalated graphite experience a residence time of 0.1 sec., the theoretical thermal shock is on the order of 80,000 deg/sec.

The present process allows for control over the C:O (carbon:oxygen) ratio of the graphite nanoplatelets. The C:O ratio may determine the electrical conductivity or ease of dispersion of the final product in a given substrate. The C:O ratio is adjustable by tuning the amount of oxygen as a second gas in the plasma expansion step.

For instance, the C:O mol ratio is greater than 50, for instance the C:O ratio is from about 50 to 200, for instance from about 50 to about 100.

The expansion ratio achieved with the plasma treatment, that is the final volume/original volume is for example greater than 80 or greater than 200. For example the expansion volume ratio achieved from the plasma treatment is from about 80 to about 180, or from about 80 to about 150.

The specific density achieved with the plasma treatment is from about 0.03 to about 0.001 g/cc. For instance, from about 0.01 to about 0.006 g/cc.

The BET surface area achieved with the plasma treatment is greater than about 30 m²/g, for example from about 60 to about 600 m²/g, for example from about 70 to about 150 m²/g.

The exfoliation step is performed by ultrasonication, wet milling or controlled cavitation. All three methods are performed “wet”, in an organic solvent or water. That is, the exfoliation step is performed on solvent dispersions of the plasma expanded graphite.

Aqueous dispersions of the expanded graphite require the use of a suitable surfactant. Suitable surfactants are anionic, cationic, nonionic or amphiphilic surfactants. Nonionic surfactants are preferred. Preferred also are nonionic surfactants containing polyethylene oxide units. The surfactants may be for example polyoxyethylene sorbates (or TWEENs). The surfactants may also be polyethylene oxide/polypropylene oxide copolymers, available as PLURONIC (BASF). The polyethylene oxide/polypropylene oxide copolymers may be diblock or triblock copolymers. The surfactants may also be polyethylene oxide/hydrocarbon diblock compounds. The surfactants may be fatty acid modified polyethylene oxides. They may be fatty acid modified polyesters.

Organic solvent dispersions may also require a surfactant, for instance a non-ionic surfactant.

Ultrasonication is performed in any commercially available ultrasonication processor or sonicator. The sonicator may be for instance from 150 W to 750 W models. Suitable are ultrasonic cleaning baths, for instance Fischer Scientific FS60 or Sonics & Materials models. The sonicator may be a probe sonicator.

Wet milling is performed with any standard bead milling apparatus. The size of the grinding beads is for instance from about 0.15 mm to about 0.4 mm. The beads are zirconia, glass or stainless steel. The gap size is from about 0.05 mm to about 0.1 mm.

Controlled cavitation is also termed “hydrodynamic cavitation”. Controlled cavitation devices are taught for instance in U.S. Pat. Nos. 5,188,090, 5,385,298, 6,627,784 and 6,502,979 and U.S. patent publication No. 2006/0126428.

The graphite nanoplatelets in each case are collected by filtration. The wet filter cake may be employed as is for incorporation into the appropriate substrate, for example plastics, inks, coatings, lubricants or greases. The filter cake may also be dried and the nanoplatelets may be re-dispersed in an aqueous or organic solvent to prepare a solvent concentrate. The solvent concentrate is likewise suitable for further inclusion into for instance plastic, inks, coatings, lubricants or greases. The filter cake or solvent concentrate may advantageously contain residual surfactant.

In certain situations, it may be possible to incorporate the “dry” graphite nanoplatelets into the suitable substrate.

It is further possible to prepare polymer concentrates or masterbatches of the graphite nanoplatelets. This is possible by combining a wet filter cake or solvent concentrate with a suitable polymer under melt conditions in a heatable container such as a kneader, mixer or extruder. The loading of the graphite nanoplatelets in the concentrates is for example from about 20 to about 60 weight percent based on the composition.

Polymer concentrates may also be prepared by a “flushing” process. Such a process is disclosed for example in U.S. Pat. No. 3,668,172. The graphite nanoplatelets are dispersed in water with the aid of a dispersant. A low molecular weight polyolefin or a similar wax is added and the mixture is subjected to stirring, heat and if necessary pressure to melt the polyolefin, whereupon the graphite is transferred from the aqueous phase into the polyolefin. The contents are cooled and filtered. The filter cake comprising the polyolefin/graphite nanoplatelet concentrate is dried. The loading of the graphite nanoplatelets in these concentrates is for example from about 20 to about 60 weight percent based on the composition.

For addition to plastics, the filter cake, solvent concentrate or polymer concentrate may be melt blended with the polymer for example in kneaders, mixers or extruders. Polymer films may be film casted from an organic solvent solution of polymer and filter cake or solvent concentrate. Polymer plaques may be compression molded from a mixture of polymer and filter cake or solvent concentrate or polymer concentrate.

The filter cake, solvent concentrate or polymer concentrate may be mixed with starting monomers of polymers; which monomers may be subsequently polymerized.

The graphite nanoplatelets prepared according to the present process are such that greater than 95% have a thickness of from about 0.34 nm to about 50 nm and a length and width of from about 500 nm to about 50 microns. For instance, greater than 90% have a thickness of from about 3 nm to about 20 nm and a length and width of from about 1 micron to about 5 microns. For instance, greater than 90% have a thickness of from about 3 nm to about 20 nm and a length and width of from about 1 to about 30 microns. For instance, greater than 90% have a thickness of from about 0.34 nm to about 20 nm and a length and width of from about 1 to about 30 microns.

The aspect ratio of the graphite nanoplatelets is high. The aspect ratio is at least 50 and may be as high as 50,000. That is 95% of the particles have this aspect ratio. For instance, the aspect ratio of 95% of the particles is from about 500 to about 10,000, for instance from about 600 to about 8000, or from about 800 to about 6000.

The platelets are measured and characterized with Atomic Force Microscopy (AFM), Transmission Electron Microscopy (TEM) or Scanning Electron Microscopy (SEM).

The sulfur content of the present graphite nanoplatelets is less than 1000 ppm by weight. For instance, the sulfur content is less than 500 ppm, for instance less than 200 ppm or from about 100 to about 200 ppm. For instance, the sulfur content is from about 50 ppm to about 120 ppm or from about 100 to about 120 ppm.

The graphite nanoplatelets of the present invention have a disorder as characterized by having a Raman spectrum G to D peak ratio greater than 1, for example from 10 to 120.

The present graphite nanoplatelets may consist of hexagonal and rhombohedral polymorphs.

The present graphite nanoplatelets for example may consist of a hexagonal polymorph with a 002 peak residing between 3.34 angstroms to 3.4 angstrom, as observed in a powder X ray diffraction pattern.

The polymer substrates of the present invention are for instance:

1. Polymers of monoolefins and diolefins, for example polypropylene, polyisobutylene, polybut-1-ene, poly-4-methylpent-1-ene, polyvinylcyclohexane, polyisoprene or polybutadiene, as well as polymers of cycloolefins, for instance of cyclopentene or norbornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).
Polyolefins, i.e. the polymers of monoolefins exemplified in the preceding paragraph, preferably polyethylene and polypropylene, can be prepared by different, and especially by the following, methods:

radical polymerization (normally under high pressure and at elevated temperature).
b) catalytic polymerization using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either π- or σ-coordinated. These metal complexes may be in the free form or fixed on substrates, typically on activated magnesium chloride, titanium(III) chloride, alumina or silicon oxide. These catalysts may be soluble or insoluble in the polymerization medium. The catalysts can be used by themselves in the polymerization or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single site catalysts (SSC).
   2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).
   3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylenepropylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.
   4. Hydrocarbon resins (for example C₅-C₉) including hydrogenated modifications thereof (e.g. tackifiers) and mixtures of polyalkylenes and starch.
   Homopolymers and copolymers from 1.)-4.) may have any stereostructure including syndiotactic, isotactic, hemi-isotactic or atactic; where atactic polymers are preferred. Stereoblock polymers are also included.
   5. Polystyrene, poly(p-methylstyrene), poly(α-methylstyrene).
   6. Aromatic homopolymers and copolymers derived from vinyl aromatic monomers including styrene, α-methylstyrene, all isomers of vinyl toluene, especially p-vinyltoluene, all isomers of ethyl styrene, propyl styrene, vinyl biphenyl, vinyl naphthalene, and vinyl anthracene, and mixtures thereof. Homopolymers and copolymers may have any stereostructure including syndiotactic, isotactic, hemi-isotactic or atactic; where atactic polymers are preferred. Stereoblock polymers are also included.
   6a. Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/butadiene, styrene/acrylonitrile, styrene/ethylene (interpolymers), styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene.
   6b. Hydrogenated aromatic polymers derived from hydrogenation of polymers mentioned under 6.), especially including polycyclohexylethylene (PCHE) prepared by hydrogenating atactic polystyrene, often referred to as polyvinylcyclohexane (PVCH).
   6c. Hydrogenated aromatic polymers derived from hydrogenation of polymers mentioned under 6a.).
   Homopolymers and copolymers may have any stereostructure including syndiotactic, isotactic, hemi-isotactic or atactic; where atactic polymers are preferred. Stereoblock polymers are also included.
   7. Graft copolymers of vinyl aromatic monomers such as styrene or α-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, MBS, ASA or AES polymers.
   8. Halogen-containing polymers such as polychloroprene, chlorinated rubbers, chlorinated and brominated copolymer of isobutylene-isoprene (halobutyl rubber), chlorinated or sulfochlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.
   9. Polymers derived from α,β-unsaturated acids and derivatives thereof such as polyacrylates and polymethacrylates; polymethyl methacrylates, polyacrylamides and polyacrylonitriles, impact-modified with butyl acrylate.
   10. Copolymers of the monomers mentioned under 9) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/alkyl methacrylate/butadiene terpolymers.
   11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1) above.
   12. Homopolymers and copolymers of cyclic ethers such as polyalkylene glycols, polyethylene oxide, polypropylene oxide or copolymers thereof with bisglycidyl ethers.
   13. Polyacetals such as polyoxymethylene and those polyoxymethylenes which contain ethylene oxide as a comonomer; polyacetals modified with thermoplastic polyurethanes, acrylates or MBS.
   14. Polyphenylene oxides and sulfides, and mixtures of polyphenylene oxides with styrene polymers or polyamides.
   15. Polyurethanes derived from hydroxyl-terminated polyethers, polyesters or polybutadienes on the one hand and aliphatic or aromatic polyisocyanates on the other, as well as precursors thereof.
   16. Polyamides and copolyamides derived from diamines and dicarboxylic acids and/or from aminocarboxylic acids or the corresponding lactams, for example polyamide 4, polyamide 6, polyamide 6/6, 6/10, 6/9, 6/12, 4/6, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with EPDM or ABS; and polyamides condensed during processing (RIM polyamide systems).
   17. Polyureas, polyimides, polyamide-imides, polyetherimids, polyesterimids, polyhydantoins and polybenzimidazoles.
   18. Polyesters derived from dicarboxylic acids and diols and/or from hydroxycarboxylic acids or the corresponding lactones, for example polyethylene terephthalate, polybutylene terephthalate, poly-1,4-dimethylolcyclohexane terephthalate, polyalkylene naphthalate (PAN) and polyhydroxybenzoates, as well as block copolyether esters derived from hydroxyl-terminated polyethers; and also polyesters modified with polycarbonates or MBS.
   19. Polycarbonates and polyester carbonates.

### 20. Polyketones.

21. Polysulfones, polyether sulfones and polyether ketones.
22. Crosslinked polymers derived from aldehydes on the one hand and phenols, ureas and melamines on the other hand, such as phenol/formaldehyde resins, urea/formaldehyde resins and melamine/formaldehyde resins.
23. Drying and non-drying alkyd resins.
24. Unsaturated polyester resins derived from copolyesters of saturated and unsaturated dicarboxylic acids with polyhydric alcohols and vinyl compounds as crosslinking agents, and also halogen-containing modifications thereof of low flammability.
25. Crosslinkable acrylic resins derived from substituted acrylates, for example epoxy acrylates, urethane acrylates or polyester acrylates.
26. Alkyd resins, polyester resins and acrylate resins crosslinked with melamine resins, urea resins, isocyanates, isocyanurates, polyisocyanates or epoxy resins.
27. Crosslinked epoxy resins derived from aliphatic, cycloaliphatic, heterocyclic or aromatic glycidyl compounds, e.g. products of diglycidyl ethers of bisphenol A and bisphenol F, which are crosslinked with customary hardeners such as anhydrides or amines, with or without accelerators.
28. Natural polymers such as cellulose, rubber, gelatin and chemically modified homologous derivatives thereof, for example cellulose acetates, cellulose propionates and cellulose butyrates, or the cellulose ethers such as methyl cellulose; as well as rosins and their derivatives.
29. Blends of the aforementioned polymers (polyblends), for example PP/EPDM, Polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.

Preferred polymer substrates are polyolefins such as polypropylene and polyethylene as well as polystyrene.

Also subject of the present invention is a polymer, coating, ink, lubricant or grease comprising the present expanded and exfoliated graphite nanoplatelets. The polymers comprising the present graphite nanoplatelets are termed polymer composites.

The polymer composites may be in the form or films, fibers or molded parts. The molded parts may be prepared for example by rotomolding or injection molding or compression molding.

The levels of graphite employed in the polymer, coating, ink, lubricant or grease substrates of the present invention are for example from about 0.1 to about 20 weight percent, based on the weight of the substrate. For instance, the level of graphite is from about 0.5 to about 15 weight percent, from about 1 to about 12 weight percent or from about 2 to about 10 weight percent, based on the weight of the substrate.

Lubricants are described for instance in U.S. Pat. No. 5,073,278, incorporated by reference.

Examples of coating compositions containing specific binders are:

1. paints based on cold- or hot-crosslinkable alkyd, acrylate, polyester, epoxy or melamine resins or mixtures of such resins, if desired with addition of a curing catalyst;
2. two-component polyurethane paints based on hydroxyl-containing acrylate, polyester or polyether resins and aliphatic or aromatic isocyanates, isocyanurates or polyisocyanates;
3. one-component polyurethane paints based on blocked isocyanates, isocyanurates or polyisocyanates which are deblocked during baking, if desired with addition of a melamine resin;
4. one-component polyurethane paints based on a Trisalkoxycarbonyltriazine crosslinker and a hydroxyl group containing resin such as acrylate, polyester or polyether resins;
5. one-component polyurethane paints based on aliphatic or aromatic urethaneacrylates or polyurethaneacrylates having free amino groups within the urethane structure and melamine resins or polyether resins, if necessary with curing catalyst;
6. two-component paints based on (poly)ketimines and aliphatic or aromatic isocyanates, isocyanurates or polyisocyanates;
7. two-component paints based on (poly)ketimines and an unsaturated acrylate resin or a polyacetoacetate resin or a methacrylamidoglycolate methyl ester;
8. two-component paints based on carboxyl- or amino-containing polyacrylates and polyepoxides;
9. two-component paints based on acrylate resins containing anhydride groups and on a polyhydroxy or polyamino component;
10. two-component paints based on acrylate-containing anhydrides and polyepoxides;
11. two-component paints based on (poly)oxazolines and acrylate resins containing anhydride groups, or unsaturated acrylate resins, or aliphatic or aromatic isocyanates, isocyanurates or polyisocyanates;
12. two-component paints based on unsaturated polyacrylates and polymalonates;
13. thermoplastic polyacrylate paints based on thermoplastic acrylate resins or externally crosslinking acrylate resins in combination with etherified melamine resins;
14. paint systems based on siloxane-modified or fluorine-modified acrylate resins.

The present graphite nanoplatelets have the following properties:
high conductivity (electrical, thermal)
lubricity
flexibility
good thermo-oxidative stability (up to 700° C.)
barrier properties
high aspect ratio (anisotropy)
high surface area (adsorption properties)
colorant
reflectivity
light weight
may be functionalized by chemical means
gas and moisture barrier properties
thermal conductivity

The possible applications include:
conductive additive in thermoplastic polymers, thermoset polymers, coatings and inks, for instance, graphite nanoplatelet filled polymers may be used for electronic packaging or tools where antistatic and electrostatic dissipative behavior is required;
coatings containing graphite nanoplatelets may be used as a conductive primer to facilitate paint adhesion to thermoplastic olefin (for example car bumpers);
epoxy filled with graphite nanoplatelets may be used for heat management in electronic applications due to the good thermal conductive properties of graphite;
mechanical reinforcement and/or barrier additive in polymers;
replacement of nanoclays for mechanical reinforcement in polymer composites;
oxygen and moisture barrier for wire and cable applications or for packaging applications;
electrodes of fuel cells, batteries, and capacitors (especially supercapacitors);
effect pigment in coatings, inks and polymers;
coatings or polymer composites may be used for radiation shielding including electromagnetic (due to its high electrical conductivity) and Infra Red (due to its reflectivity);
lubricant applications especially in high temperature greases, motor oils, mold release coatings, and metal working fluids;
adsorption applications such as water filtration and removal of organic pollutants and oil spill clean-up;
mechanical reinforcement of polymers.

Thin films of graphite nanoplatelets may be useful as transparent conductive films as a replacement for indium tin oxide (ITO).

The following examples are illustrative of the present invention. Unless indicated otherwise, parts and percents are by weight.

### BRIEF DESCRIPTION OF THE FIGURES

FIG. 1 is a Raman characterization of 9 particles of graphite nanoplatelets of Example 4. The 9 particles represent a range of thicknesses from monolayer graphene to multi-layer graphene. More fully described in Example 10.

FIG. 2 is Raman spectra comparing the intensity of the D and G peaks. The low intensity of the D peak is an indication of a low amount of structural disorder such as folding, line defects, and oxygen functional groups. More fully described in Example 10.

FIGS. 3 and 4 are powder X-ray diffraction results for graphite nanoplatelets of Examples 4 and 5. More fully described in Example 12.

The following Examples illustrate the invention. Unless otherwise stated, all parts and percentages are by weight. All surface resistivity data is in ohm/square and all volume resistivity data is ohm-cm.

### EXAMPLE 1

### Thermal Plasma Expansion of Intercalated Graphite

An expandable graphite powder (Grafguard® 220-80N) is fed at a rate of 2 kg/hour into a plasma reactor with a Tekna PL-70 plasma torch operated at a power of 80 kW. The sheath gas is 150 slpm argon [slpm=standard liters per minute; standard conditions for the calculation of slpm are defined as: Tn 0° C. (32° F.), Pn=1.01 bara (14.72 psi)] and the central gas is argon at 40 slpm. To prepare expanded graphite with increased oxygen content, oxygen is blended with the argon sheath gas. The amount of oxygen introduced to the sheath gas is fine tuned to prevent substantial combustion of the intercalated graphite. The operating pressure is maintained at slightly lower than atmospheric pressure (700 torr). An injection probe designed for powder injection with dispersion is positioned to allow for maximum expansion without significant vaporization of the graphite flakes. The expanded flakes are collected in a filter after passing a heat exchange zone.

The expanded flakes are analyzed by elemental analysis for C, H, N, and S by combustion and O by difference (Atlantic Microlab, Inc.). The sulfur content for the expanded material yielded an average of 0.81% for samples produced with a sheath gas mixture of either Ar/He or Ar/O₂. The expanded graphite flakes which are thermally processed with oxygen injected into the argon sheath gas gives a C/O ratio of 198 for 1.7 slpm oxygen in the sheath gas, whereas flakes processed with 5 and 9 slpm oxygen in the sheath gas yields expanded graphite with C/O mol ratios of 67 and 58, respectively.

The C/O mol ratio of the present expanded graphite flakes is for instance >50, for instance from about 50 to 200, for instance from about 50 to about 100.

The expanded flakes are analyzed for nitrogen BET surface area using the multi-point method (5 points, BET=Brunauer, Emmett, and Teller). Elemental analysis is performed on the expanded flakes for C, H, N, and S by combustion and O by difference (Atlantic Microlab, Inc.). The sulfur content for the expanded material yields an average of 0.81% for samples produced with a sheath gas mixture of either Ar/He or Ar/O₂. A table summarizing the BET surface area and C/O ratio for samples of expanded graphite produced with different oxygen content in the sheath gas is shown below. The surface area is observed to increase with higher oxygen content of the sheath gas, while the C/O ratio is observed to decrease.

| Oxygen Content of Sheath | BET Surface | |
|---|---|---|
| Gas (slpm) | Area (m²/g) | C/O ratio |
| 1.7 | 68.5 | 198 |
| 5 | 83.4 | 67 |
| 9 | 130.6 | 58 |

By varying the oxygen level in the plasma, one can modify the surface area and the C/O ratio of the material.

### EXAMPLE 2

### Wet Milling of Expanded Graphite

A Dyno®-Mill KDL agitator bead mill equipped with 0.3 mm zirconia grinding beads and 0.01 mm gap width is used to exfoliate and disperse the plasma-expanded graphite. A peristaltic pump is used to continuously charge the Dyno®-Mill (600 cc capacity) during the milling process.

Typically, stable dispersions are produced starting from a maximum concentration of 0.5 wt % of plasma-treated graphite in DRAKEOL® 34 mineral oil (Penreco®). The low weight percent is due to the initial viscous nature of the mixture. If concentrations greater than 0.5 wt % are desired, the procedure can be repeated by adding an additional amount of plasma-expanded graphite to the previously milled end product after the 1^{st} pass. The concentration can be increased up to 2.0 wt % by adding plasma-treated graphite in increments of 0.5 wt % (concentrations greater than 2.0 wt % become very viscous and are difficult to pump). The graphite/mineral oil mixture is passed through the Dyno®-Mill at least twice.
1. Into a 7-liter stainless steel beaker, the following is added:
   a. 4 liters of Penreco® DRAKEOL® 34 mineral oil
   b. 20.0 g of plasma-treated graphite
   At first, the dry plasma-expanded graphite is difficult to “wet out” (ie. the expanded graphite will float on top of the mineral oil). Stirring by overhead mechanical stirrer or by hand is necessary in order to insure the expanded graphite is entrained with the mineral oil being pumped into the Dyno®-Mill.
2. Continuously charge the Dyno®-Mill at a pump rate of approximately 60-70 mL/min.
3. Collect the Dyno®-Mill outflow in an empty 7-liter stainless steel beaker.
   (If a more concentrated sample is desired, add an additional 0.5 wt % of plasma-treated graphite to the collected 1^{st} pass.)
4. Once the entire graphite/mineral oil sample has been milled, repeat the process for a total of two passes through the Dyno®-Mill. Second pass retained samples show little or no settling of the graphite.
5. Vacuum filter the graphite/mineral oil sample using WHATMAN #1 filter paper and collect the milled expanded graphite.
6. The collected graphite filtercake is a solid which contains approximately 85 wt % mineral oil and 15 wt % exfoliated graphite.
7. The filtercake may be readily redispersed in appropriate media.

### EXAMPLE 3

### Wet Milling of Expanded Graphite

An aqueous dispersion of exfoliated graphite is prepared by repeating the protocol from Example 2 but replacing mineral oil with an equal volume of water. In addition to water, a dispersant is used which serves to compatibilize the graphite with water. PLURONIC P123 (BASF) is first dissolved in 4 L of water such that a 1:1 weight ratio of PLURONIC P123 to plasma expanded graphite is obtained. Typically, the initial concentration of expanded graphite is 1-2 wt % in water, however the aqueous dispersion is made more concentrated (up to 5 wt %) than the mineral oil dispersions due to viscosity.

The aqueous dispersion is filtered by vacuum filtration using a WHATMAN #1 filter paper to collect the milled expanded graphite. The filtercake contains approximately 90% water, 8% exfoliated graphite and 2% residual PLURONIC P123. The filtercake may readily redispersed in appropriate media. Additionally, the filtercake may be further dried by vacuum oven to remove the water. The dry filtercake may be redispersed in appropriate media by stirring or short ultrasonication.

### EXAMPLE 4

### Ultrasonication of Expanded Graphite

Ultrasonication is used to exfoliate plasma-expanded graphite and create a stable dispersion in water or non-aqueous liquids. Into a 2-liter flask, 1.5 liters of liquid are added. If the liquid is mineral oil, no dispersant is required. For aqueous dispersions, 4 g of PLURONIC P123 is added to 1.5 L of water. For toluene, 4 g of Efka 6220 is added (fatty acid modified polyester). The mixture is stirred until dissolved. Gentle heat is applied if necessary. 4.0 g of plasma-expanded graphite is added to the 1.5 L of liquid. The contents are then stirred in order to initially wet the expanded graphite which tends to float on top of the liquid. With the aid of a 750-watt ultrasonic processor (VCX 750 Sonics & Materials, Inc.), the liquid/graphite mixture is ultrasonicated @40% intensity for a total of 40 minutes. A pulse method (10 seconds ON—10 seconds OFF) is used to prevent over heating. During the ultrasonic treatment, a noticeable reduction in particle size is observed and particles become suspended (no settling occurs upon standing). If a solid material is desired, the dispersion is vacuum filtered using a WHATMAN #1 paper filter. The filter cake from mineral oil contains 85 wt % mineral oil and 15 wt % graphite, where as the toluene and water filter cakes contain about 90 wt % liquid, 8 wt % graphite and 2 wt % residual dispersant.

### EXAMPLE 5

### Controlled Cavitation of Expanded Graphite

Apparatus employed is a HydroDynamics, Inc. SHOCKWAVE POWER™ REACTOR (SPR). 17 lbs of molten PLURONIC P123 is added to a 200 gallon stainless steel vessel containing 830 lbs of water. The contents are agitated by a mechanical stirrer. 17 lbs of thermal plasma-expanded graphite are charged in 1-2 lb increments. The recirculation pump and SPR are turned on to ensure a flow rate of 10-15 GPM through the re-circulation loop between the stainless steel vessel and SPR. Once the thermal plasma-expanded graphite is fully charged, the SPR is set to 3600 rpm and maintained for 5 hrs. The product is monitored throughout the process by pulling a sample of the graphite dispersion and measuring the particle size by light scattering (Malvern Mastersizer 2000). The nano-scaled graphite particles are isolated from the aqueous dispersion by filtration with a Nutsche Filter over a period of 3-8 hrs. The filter cake contains approximately 90% water, 8% exfoliated graphite, and, 2% residual PLURONIC P123.

The dried filter cake is analyzed by elemental analysis for C, H, N, and S by combustion (Atlantic Microlab, Inc.). Nitrogen is not detectable and the sulfur content is found to be 0.11%.

### EXAMPLE 6

### Formation of Free Standing Films Comprised of Graphite Nanoplatelets

A dispersion of graphite nanoplatelets such as produced from ultrasonic processing of plasma expanded graphite or re-suspension of a filter cake produced by the method described in Example 4 is vacuum filtrated on a 1 inch diameter WHATMAN #1 filter paper. The filtration is done at such a speed to allow for the graphite nanoplatelets to pack into a dense film. The film is fully dried in a vacuum oven at low temperature (50° C.). After full drying, the film may be removed from the filter paper by pulling at an edge with metal tweezers. Film thicknesses of 20 to 200 microns are achieved by varying the concentration of the graphite dispersion with respect to the area of the filter paper. The resulting free standing graphite nanoplatelet film is observed to be mechanically robust to bending and pulling, while having a low surface resistivity of 0.5 ohm/square for a 20 micron thick film.

The films of this invention may be employed as an electrode in fuel cells, batteries or supercapacitors. They may be useful as a membrane in water purification.

### EXAMPLE 7

### Incorporation of Graphite Nanoplatelets into Polyacrylate Thin Films

In a 100 mL test tube, the following are added:
a) 6 g of PARALOID B-66 thermoplastic acrylic resin (Rohm & Haas, containing 50% solids=3 g solid wt.)
b) 5 mL toluene
c) Dried filter cake produced by the method described in Example 4

The mixture is processed by a 750 W ultrasonic probe for 30 seconds to 1 minute or until the graphite nanoplatelets appear to be in suspension. Using a 20-mil applicator drawdown bar, a 20-mil thin film is prepared onto test paper (Garner byko-charts, reorder #AG5350). The dry thin film sample is dried under moderate heat with a heat gun. The surface resistivity is measured in ohms using EST-842 Resistance/Current Meter.

| Weight % Graphite | |
|---|---|
| Nanoplatelets | Surface Resistivity (ohm/square) |
| 0.20 | 7.44E+12 |
| 0.43 | 2.08E+12 |
| 0.81 | 8.02E+08 |
| 1.58 | 1.59E+04 |
| 2.36 | 1.12E+03 |
| 3.02 | 5.07E+02 |

### EXAMPLE 8

### Incorporation of Graphite Nanoplatelets into Polystyrene

In a 2-liter flask, the following are added:
a) 36.0 g polystyrene (Mn-260,000)
b) 4.0 g Efka-6220 (fatty acid modified polyester)
c) 1.5 liters of reagent-grade toluene

The contents of the flask are stirred until dissolved. A chosen amount of plasma expanded graphite is added to the flask. With the aid of a 750-watt ultrasonic probe, the toluene/Efka-6220/graphite mixture is processed at 40% intensity for a total of 40 minutes. A pulse method (10 seconds ON—10 seconds OFF) is used to prevent over heating. During sonication a noticeable reduction in particle size is observed and particles become suspended (no settling occurs). 1 liter of toluene is removed by vacuum distillation. The remaining graphite/polystyrene/toluene mixture is poured into a flat-bottom 12″×8″ Pyrex glass dish and oven dried at 60° C. under a low stream of nitrogen overnight. The remaining solid is removed from the Pyrex dish. The surface resistivity of polystyrene containing 4 wt % graphite nanoplatelets is measured to be 60 ohm/sq.

### EXAMPLE 9

### Incorporation of Graphite Nanoplatelets into Polyurethane Thin Films

In a 100 ml test tube, the following are added:
a) 20 mL of a 5% aqueous PLURONIC P-123 (surfactant) solution (1 g solid wt. of PLURONIC P-123)
b) 10 g of WITCOBOND W-234 (containing 30% solids=3 g solid wt.)
c) Amount of plasma-expanded graphite to achieve desired concentration of total solids*

The mixture is ultrasonicated for 20 minutes or until no further exfoliation is observed. This state is reached when the graphite particles appear very fine and are in suspension. Using a 10-mil applicator drawdown bar, a 10-mil thin film is cast onto test paper (Garner byko-charts, reorder #AG5350). The thin film sample is oven dried at 120° C. The surface resistivity is measured in ohms using EST-842 Resistance/Current Meter.

WITCOBOND W-234 contains: aqueous polyurethane, water, N-polymethylpyrrolidione (contains 30% solids)
*Total solids equals:

### 1) 1 g of PLURONIC P-123

2) 3 g of WITCOBOND polyurethane-based polymer
3) amount of exfoliated graphite added

| Weight % Graphite | |
|---|---|
| Nanoplatelets | Surface Resistivity (ohm/square) |
| 1 | 0.1 × 10⁹ |
| 2 | 0.6 × 10⁹ |
| 3 | 28.4 × 10³ |
| 4 | 6.9 × 10³ |

### EXAMPLE 10

### Confocal Raman Characterization of Graphite Nanoplatelets

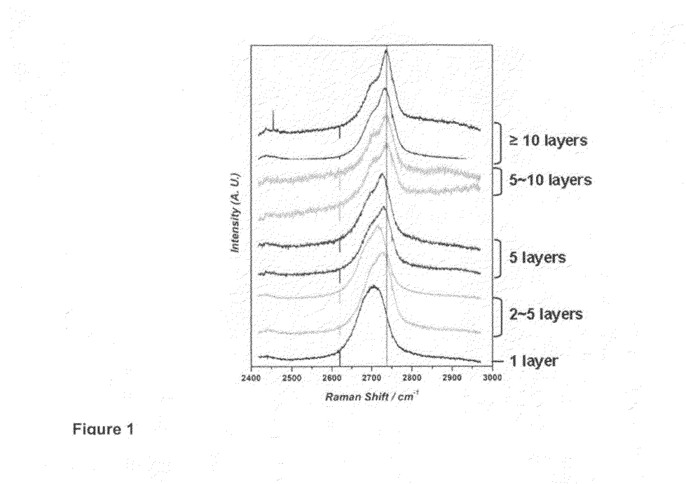

A water filter cake produced by the ultrasonication method described in Example 4 is re-suspended in water by short ultrasonic treatment. The sample is allowed to stand overnight. The suspended portion is referred to as the supernatant. Several drops of the supernatant are spin-cast onto a silicon wafer at 1500 rpm. Raman measurements are performed at room temperature with a T 64000 Jobin-Yvon Raman spectrometer equipped confocal microscope and XYZ sample stage. The Raman spectra are acquired with a 488 nm laser excitation. The signal is collected in backscatter geometry using a ×50 objective lens (N.A.=0.5). Spectra are taken by focusing the Raman laser on isolated individual graphite nanoplatelets. In FIG. 1, nine spectra from nine particles are overlaid for the spectral region from 2400 to 3000 cm⁻¹. This is the region where the so-called 2D peak is commonly observed. For reference, the identification of graphene and multilayered graphene by Raman spectroscopy have been reported by Ferrari et. al. Phys. Rev. Let. 2006, 97, 187401. In the case of a single-layer graphene, the spectra should be composed of one narrow symmetrical lower-frequency 2D peak centered ˜2700 cm⁻¹. It can be determined by comparing our spectra with the reference spectra of Ferrari that the 9 particles represent a range of thicknesses including monolayer graphene, bi-layer graphene and multi-layered graphene. The thicknesses of the 9 particles can be summarized as follows: 2≧10 graphene layers, 2 between 10 and 5 layers, 2 of 5 layers, 2 between 5 and 2 layers, and 1 which is monolayer graphene.

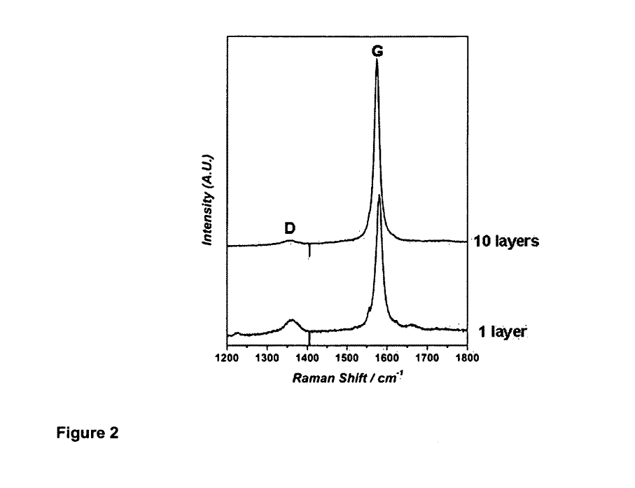

Raman spectroscopy can also be used to observe the disorder of graphitic materials by comparing the intensity of the D and G peaks. The region from 1200-1800 cm⁻¹ where the D and G peaks occur is shown in FIG. 2 for graphite nanoplatelets of 10 layer thickness and 1 layer thickness. The low intensity of the D peak in comparison to the G peak is an indication of a low amount of structural disorder such as folding, line defects, and oxygen functional groups in the nanoplatelets. If the D peak is of comparable or greater intensity than the G peak, both the mechanical and electrical properties of the graphite will be deleteriously impacted since the conjugated sp² carbon network is disturbed. It is therefore desirable to have graphite nanoplatelets with a low intensity D peak in order to capitalize on the high electrical conductivity and high mechanical strength of graphite. A certain amount of oxygen functionality may be desired to achieve compatibility with a chosen substrate, as long as the oxygen functionality does not disturb the properties inherent to graphite or graphene.

### EXAMPLE 11

### Atomic Force Microscopy (AFM) Characterization of Graphite Nanoplatelets

Filter cakes produced by the methods described in Examples 4 and 5 are re-suspended in water by short ultrasonic treatment. Samples are prepared by spin-casting the aqueous dispersion onto highly orientated pyrolytic graphite (HOPG) from Momentive Performance Materials. The AFM used in this study is MFD-3D-BIO™ from Asylum Research. The cantilever probes used for imaging are NP-S type with oxide-sharpened and gold-coated silicon nitride (k=0.32, r=20 nm) from Veeco Probes. Contact-mode imaging is performed on all the samples.

The thickness (t) distribution for 6 samples are listed in the table below. Samples McB1, McB2, McB3, and McB4 are prepared from the controlled cavitation method described in Example 5 and whereas samples B17 and G3907 are prepared from the ultrasonication method described in Example 4. The average thickness for all samples is determined to be around 7-8 nm.

| t (nm) | McB1 | McB2 | McB3 | McB4 | B17 | G3907 |
|---|---|---|---|---|---|---|
| <3 | | | 2 | 4 | 1 | 1 |
| 3~4 | 6 | 1 | | 7 | 2 | |
| 5~6 | 5 | 2 | 8 | 2 | 3 | 1 |
| 7~8 | 5 | 4 | 11 | 6 | 2 | 2 |
| 9~10 | 5 | 3 | 7 | 4 | 5 | 5 |
| 11~12 | | | 3 | 2 | 2 | 1 |
| 13~14 | 2 | | | 2 | | |
| ≧15 | 1 | | | 2 | | |
| total # of | 24 | 10 | 31 | 29 | 15 | 10 |
| particles | | | | | | |
| examined | | | | | | |
| Average | 7.38 nm | 7.44 nm | 7.52 nm | 7.75 nm | 7.41 nm | 8.56 nm |
| Thickness | | | | | | |

### EXAMPLE 12

### Powder X-Ray Diffraction (PXRD) Characterization of Graphite Nanoplatelets

Wet filter cakes produced by the methods described in Examples 4 (ultrasonication) and 5 (controlled cavitation), referred to as McB4 and TcB6, respectively, are cut to 2 mm height and placed into a polycarbonate sample holder with a 2 mm recession. The samples are purposefully handled as wet filter cakes in order to prevent re-assembly of the graphite platelets on drying and to minimize preferred orientation. The samples are analyzed on a standard Bragg-Brentano Siemens D5000 diffractometer system. A high-power Cu-target is used operating at 50 kV/35 mA. The data is collected in step scan mode with 0.02° 2-theta step size and 1.5-2.0 seconds per step count time. The data processing is performed on Diffrac Plus™ software Eva™ v. 8.0. The profile fitting is carried out by Bruker AXS Topas™ v. 2.1.

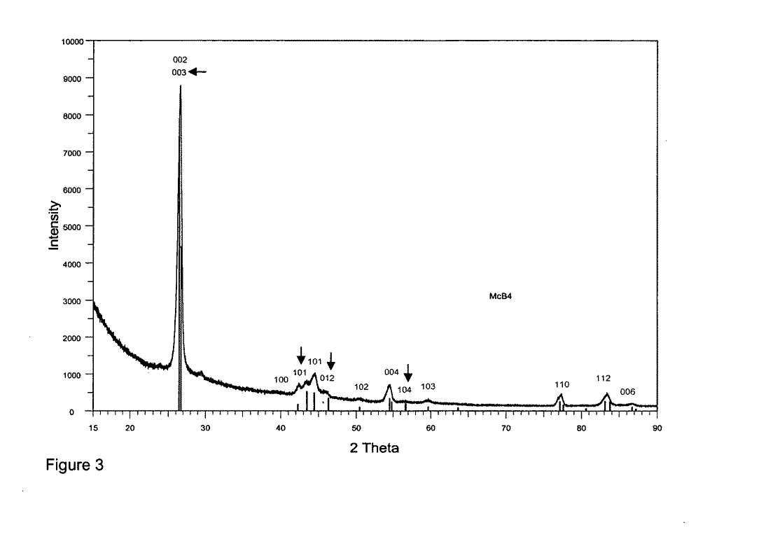

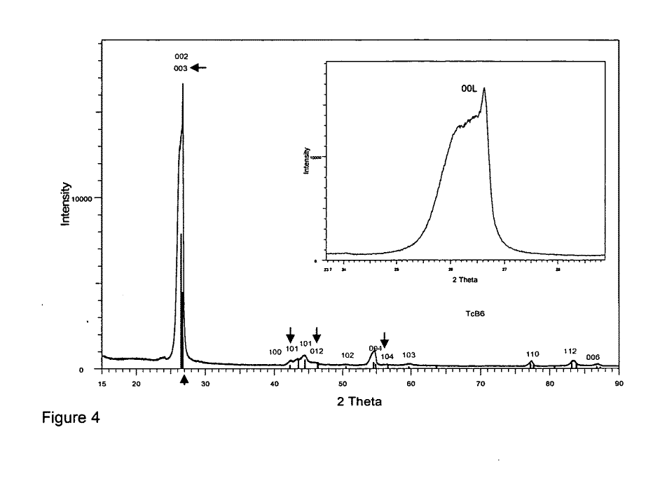

The PXRD patterns for McB4 and TCB6 are shown in FIGS. 3 and 4, respectively. Both samples are found to consist of hexagonal, 2H, and rhombohedral, 3R, polymorphs of graphite. The 3R reflections are pointed out with arrows in FIGS. 3 and 4. A profile fitting/decomposition procedure using Topas™ is performed to determine the domain size along each reflection. The domain sizes for the 2H polymorph are shown in the table below. The domain sizes (Lᵥₒₗ) for McB4 are about 11 nm along the 00L direction and 6-15 nm for the HKL directions. The 00L direction represents the thickness of the graphite platelets. The domain size for the 3R polymorph are found to be 5.5 nm for the 101 direction and 6.7 nm for the 012 direction (not reported in Table).

For sample TcB6, the 00L peak appears distorted and requires de-convolution to separate it into a broad 00L peak and narrow 00L(A) peak. The broad 00L peak is displaced to slightly higher d-spacing (3.40 Å) than expected for graphite (3.34 Å), whereas the narrow 00L(A) peak resides at exactly 3.34 Å. The peak shift for 00L is indicative of disordered graphene layers which are separated further than the natural Van der Waals spacing would normally allow. The domain sizes (Lᵥₒₗ) for TcB6 are about 11 nm for the 00L reflection and 30 nm for the 00L(A) reflection.

| | Position | H K L | Lᵥₒₗ (nm) | Error |
|---|---|---|---|---|
| McB4 | | | | |
| 2H-00L | 26.420 | 002 | 11.31 | 0.19 |
| | 54.402 | 004 | 11.47 | 1.28 |
| | 86.701 | 006 | 11.07 | 1.15 |
| Gr-2H-HKL | 42.295 | 100 | 11.48 | 5.58 |
| | 44.379 | 101 | 7.74 | 1.48 |
| | 50.422 | 102 | 12.87 | 5.01 |
| | 59.643 | 103 | 5.93 | 1.64 |
| | 77.213 | 110 | 15.06 | 1.49 |
| | 83.328 | 112 | 10.41 | 1.30 |
| TcB6 | | | | |
| Gr-2H-00L | 26.121 | 002 | 11.37 | 0.09 |
| | 54.233 | 004 | 12.41 | 0.76 |
| | 86.777 | 006 | 10.60 | 1.68 |
| Gr-2H- | 26.582 | 002 | 32.88 | 0.58 |
| 00L(A) | 54.654 | 004 | 28.73 | 3.02 |

### EXAMPLE 13

### Transparent Conductive Films Comprised of Graphite Nanoplatelets

A filter cake produced by the method described in Example 4 is re-suspended in water by short ultrasonic treatment. The graphite nanoplatelet dispersion is vacuum filtered onto a porous mixed cellulose ester membrane. Typical film thicknesses range from 50 nm to 300 nm. The films can be transferred to a preferred substrate such as glass by one of the following routes:

a) the membrane can either be dissolved in acetone after which the film will float on top of the solvent where it can be picked up on a substrate on choice.

b) the film can be directly transferred from the cellulose membrane by applying pressure between the film and a substrate.

A 100 nm graphite nanoplatelet film can have a surface resistivity of 50 ohm/square and about 70% transmittance in the visible spectral region.

### EXAMPLE 14

### Conductive Films of Graphite Nanoplatelets

Clean glass microscope slides are heated to 120° C. using a hotplate. An aqueous dispersion of dried filter cake produced by the method described in Example 4 is sprayed with an airbrush onto the glass slides until the desired coating level is achieved. The slides are then heated at 375° C. in air to remove the dispersant. Surface resistivity is measured using a 4-point probe (Lucas Labs). The surface resistivity and the transmittance measured at 550 nm of selected examples are tabulated below:

| | Surface Resistivity | Transmittance |
|---|---|---|
| Sample | (ohm/square) | at 550 nm |
| 1 | 1.4E+3 | 27 |
| 2 | 2.6E+3 | 41 |
| 3 | 4.9E+3 | 43 |
| 4 | 2.0E+4 | 61 |

Surfactant-free graphite nanoplatelets are obtained by calcination of 1.0 g of dried filter cake produced by the method described in Example 4 at 400° C. for 3 hours. 0.85 g of the graphite nanoplatelets remain after heating. 27 mg of the surfactant-free graphite nanoplatelets are dispersed in 50 mL dimethylformamide (DMF) with the aide of sonication. The dispersion is allowed to settle for ten days to remove the larger platelets. The DMF dispersion is decanted from the larger platelets. Clean glass microscope slides are heated to 160° C. using a hotplate, and the DMF dispersion is sprayed with an airbrush onto the glass slides until the desired coating level is achieved. The slides are the heated at 375° C. in air to remove residual DMF. Surface resistivity is measured using a 4-point probe (Lucas Labs). The surface resistivity and the transmittance measured at 550 nm of selected examples are tabulated below:

| | Surface Resistivity | Transmittance at |
|---|---|---|
| Sample | (ohm/square) | 550 nm |
| 1 | 4.4E+2 | 33 |
| 2 | 8.9E+2 | 40 |

### EXAMPLE 15

### Polymer/Graphite Nanoplatelet Composites

A series of polymer composites is prepared in order to assess the weight loading of graphite nanoplatelets to achieve the percolation threshold required for electrical conductivity. The composites are prepared generally according to the following method:

1. A graphite nanoplatelet filter cake as described in present Examples 4 or 5 is combined with a low molecular weight polymer vehicle chosen for good compatibility with the final polymer matrix. The filter cake is combined with the vehicle in a heatable container such as a kneader, mixer or extruder. Alternatively, the filter cake is combined with the vehicle by a flushing process. The resulting powder is a polymer/graphite nanoplatelet concentrate.

2. Polymer resin in the form of powder and the polymer concentrate are dry blended to achieve a series of mixtures, for instance containing 2, 4, 6, 8, 10 and 12 weight percent graphite nanoplatelets. The mixtures are compounded with a twin-screw or single-screw extruder using processing conditions required for the chosen polymer substrate.

3. The extrudate is used to prepare plaques using compression, injection or rotomolding processes.

For instance, polypropylene/graphite nanoplatelet plaques are prepared as follows. A 50 weight percent concentrate is prepared from graphite nanoplatelets and low molecular weight polyethylene wax (AC617A, Honeywell). The concentrate is prepared by melt mixing or flushing. The concentrate and polypropylene resin (PROFAX 6301, Basell) powders are dry blended to achieve powder mixtures of 2, 4, 6, 8 and 10 weight percent graphite based on the composition. The powder mixtures are melt mixed with a DSM micro 15 twin screw extruder (vertical, co-rotating) at 150 rpm for 3 minutes. The melting zone temperature is 200° C. Subsequently, a DSM 10 cc injection molder is used to prepare composite samples in the form of rectangular plaques. The molten mixture is collected in a heated transfer wand and injected at 16 bar into the mold held at 60° C.

Volume resistivity is obtained from the polymer composites by cryo-fracturing the plaque to remove the two ends. Silver paint (SPI FLASH-DRY silver paint) is applied to the ends for good contact.

Volume resistivity results for injection molded plaques of polypropylene, nylon and polycarbonate are below.

| | |
|---|---|
| wt. percent | volume resistivity (ohm-cm) |

| graphene | nylon | polypropylene | polycarbonate |
|---|---|---|---|
| 2 | 8.3E12 | 1.1E12 | 8.0E10 |
| 4 | 8.1E11 | 8.2E10 | 1.0E6 |
| 6 | 2.5E8 | 1.9E6 | 2.0E3 |
| 8 | 1.6E5 | 2.6E4 | 4.0E2 |
| 10 | 1.0E4 | 3.9E3 | — |

### EXAMPLE 16

### Water Based Inks

A polyethylene wax/graphite nanoplatelet concentrate is prepared according to a present “flushing” process. The concentrate is 80% polyethylene wax and 20% graphite by weight. The filter cake of Example 5 is employed.

One kilogram of vinylketone type clear varnish is prepared by mild stirring at 3000 rpm for 30 minutes at room temperature of a formulation containing 100 g of 1-ethoxypropanol, 760 g methylethylketone and 140 g of VMCH, a carboxy modified vinyl copolymer.

A vinylketone ink is prepared by dispersing in a SKANDEX shaker for 2 hours in a 400 mL glass bottle 1.5 parts of the wax/graphite concentrate and 98.5 parts of clear varnish with 230 g of glass beads (2 mm diameter). After centrifugation and removal of the glass beads, the ink is applied by a hand coater at a 50 micron wet film thickness on black and white contrast paper. An opaque dark grey print with very fine sparkling metallic effect results.

Alternatively, the aqueous filter cake from Example 4 may be employed in place of the wax/graphite concentrate. An opaque dark grey print with very fine sparking metallic effect results.

### EXAMPLE 17

### Lubricants

A blend of 0.25 weight percent graphene filter cake with a fatty acid modified polyamide dispersant in a base oil is prepared. The base oil is a Group II viscosity grade 32 hydrocarbon oil. The wear performance is measured using the four-ball ASTM D4172 method (75° C., 1200 rpm, 60 min., 392 N). Measurements of the wear scars revealed that there was a decrease in size relative to the base oil alone. The blend is also tested according to the high frequency reciprocating rig (HFRR) test method, using a load of 200 g at 160° C. for 75 minutes with a vibration frequency of 20 Hz. The resulting coefficient of friction is decreased as compared to the base oil with no additive. The average film created is significantly improved. A higher film value generally correlates with a lower coefficient of friction and less wear.

1. Graphite nanoplatelets produced by a process which comprises
thermal plasma expansion of intercalated graphite to produce expanded graphite followed by
exfoliation of the expanded graphite,
where the exfoliation step is selected from ultrasonication, wet milling and controlled caviation and
where greater than 95% of the graphite nanoplatelets have a thickness of from about 0.34 nm to about 50 nm and a length and width of from about 500 nm to about 50 microns.

2. Graphite nanoplatelets according to claim 1 where the intercalated graphite is intercalated with a mixture of sulfuric and nitric acids.

3. Graphite nanoplatelets according to claim 1 where the expansion ratio achieved in the thermal plasma expansion is greater than 80 and where the specific density of the expanded graphite is from about 0.01 to about 0.006 g/cc.

4. Graphite nanoplatelets according to claim 1 where the BET surface area of the expanded graphite is from about 60 to about 600 m²/g.

5. Graphite nanoplatelets according to claim 1 where the exfoliation step is ultrasonication.

6. Graphite nanoplatelets according to claim 1 where the exfoliation step is wet milling where the size of the grinding beads is from about 0.15 mm to about 0.4 mm and the beads are zirconia, glass or stainless steel.

7. Graphite nanoplatelets according to claim 1 where the exfoliation step is controlled cavitation.

8. Graphite nanoplatelets according to claim 1 where the exfoliation step is performed in an aqueous or organic solvent.

9. Graphite nanoplatelets according to claim 1 where greater than 90% of the nanoplatelets have a thickness of from about 3 nm to about 20 nm and a width of from about 1 micron to about 30 microns.

10. Graphite nanoplatelets according to claim 1 where 95% of the nanoplatelets have an aspect ratio of at least 50.

11. A composition comprising a plastic, ink, coating, lubricant or grease substrate, which substrate has incorporated therein graphite nanoplatelets,
where the graphite nanoplatelets are produced by a process which comprises
thermal plasma expansion of intercalated graphite to produce expanded graphite followed by
exfoliation of the expanded graphite,
where the exfoliation step is selected from ultrasonication, wet milling and controlled caviation and
where greater than 95% of the graphite nanoplatelets have a thickness of from about 0.34 nm to about 50 nm and a length and width of from about 500 nm to about 50 microns.

12. A composition according to claim 11 comprising a plastic substrate.

13. A composition according to claim 11 comprising a plastic substrate selected from polypropylene, polyethylene and polystyrene.

14. A composition according to claim 11 comprising an ink or a coating substrate.

15. A composition according to claim 11 comprising a lubricant or a grease substrate.

16. A composition according to claim 11 comprising from about 0.1 to about 20 weight percent graphite nanoplatelets based on the weight of the substrate.

17. A composition according to claim 11 where the exfoliation step is ultrasonication.

18. A composition according to claim 11 where the exfoliation step is wet milling where the size of the grinding beads is from about 0.15 mm to about 0.4 mm and the beads are zirconia, glass or stainless steel.

19. A composition according to claim 11 where the exfoliation step is controlled cavitation.

20. A composition according to claim 11 where greater than 90% of the nanoplatelets have a thickness of from about 3 nm to about 20 nm and a width of from about 1 micron to about 30 microns.
